(19) United States
(12) Patent Application Publication
(10) Pub. No.: US 2003/0054132 A1
(43) Pub. Date: Mar. 20, 2003

(54) Snow melt paper

(76) Inventor: Jarrett B. Maupin, Phoenix, AZ (US)

Correspondence Address: James J. Kernell, Chase & Yakimo, L.C., Suite 130, 4400 College Boulevard, Overland Park, KS, 66211, US

(21) Appl. No.: 09/953,819

(22) Filed: Sep. 17, 2001

(51) Int. Cl. B32B 3/10

(52) U.S. Cl. 428/137; 428/354

(57) ABSTRACT

A snow and ice prevention paper having a layer of de-icing composition bonded to a substrate such as paper, plastic or other sheet material. The snow and ice prevention paper includes an adhesive or anti-slip backing to keep the paper in place upon porches, steps, sidewalks, driveways, truck beds, etc.

### BACKGROUND OF THE INVENTION

The present invention relates to preventative safety materials and, more particularly, to a material that prevents the buildup of snow and ice on sidewalks, steps, driveways, etc. which is contained to a desired area and is easily removed.

It is known in the art to heat sidewalks, driveways and road surfaces to prevent formation of snow and ice. The heat is typically produced by electrical heating elements or hot water pipes embedded beneath the treated surface. These systems are typically expensive to install, operate and maintain.

It is also known to spread granular or liquid salt or other de-icing compositions over a surface to melt existing ice or snow or to prevent buildup. These compositions are typically spread by hand, use of mechanical lawn broadcast-type spreaders or by a spreader or spray truck. The effect of applying these compositions is generally short term as traffic over the treated area tends to crush the composition particles and push them to the sides of the treated surface. Water from the melted snow or ice containing the salt or deicing composition drains away from the treated surface into the surrounding soil or into streams, creeks and lakes. Additional salt or de-icing composition is applied and the cycle is repeated. The spray or granules may also be misapplied such that they miss the target surface entirely, landing instead along the side of the walkway, driveway or road.

These problems create an economic and safety burden on homeowners, business owners and other maintenance and safety departments in terms of time spent retreating surfaces and the expense of the additional material. These problems also create an environmental problem by directly damaging the environment surrounding the treated surface, and the collateral environment affected by the runoff.

### SUMMARY OF THE INVENTION

It is therefore a primary object of the present invention to provide a snow and ice-melt mat system with a de-icing compound bound to the mat substrate.

Another important object of the present invention is to provide a snow and ice-melt mat system, as aforesaid, which retains the de-icing compound in the desired application area.

Still another important object of the present invention is to provide a snow and ice-melt mat system, as aforesaid, that remains in place until removed.

Yet another important object of the present invention is to provide a snow and ice-melt mat system, as aforesaid, that is disposable.

These and other objects of the invention are achieved by binding a snow and ice-melt compound to a substrate such as heavy paper. The mat is held in place by a pressure sensitive adhesive or by a non-slip or skid strips on the back of the paper. The mat may be placed on a porch, steps, sidewalk and driveway, for example, to prevent or limit accumulation of snow and ice.

Other objects and advantages of this invention will become apparent from the following description taken in connection with the accompanying drawings, wherein is set forth by way of illustration and example, a now preferred embodiment of this invention.

### BRIEF DESCRIPTION OF THE DRAWINGS

FIG. 1 is a top plan view of the present invention;

FIG. 2 is a bottom view of the present invention;

FIG. 3 is an enlarged diagrammatic sectional illustration of the invention of FIG. 1 along line 3-3;

FIG. 4 is a diagrammatic illustration of the present invention applied to a set of stairs and walkway;

FIG. 5 is a diagrammatic illustration of the present invention applied to a driveway and sidewalk in front of a house;

FIG. 6 is an enlarged diagrammatic sectional view of another embodiment of FIG. 3.

### DESCRIPTION OF THE PREFERRED EMBODIMENT

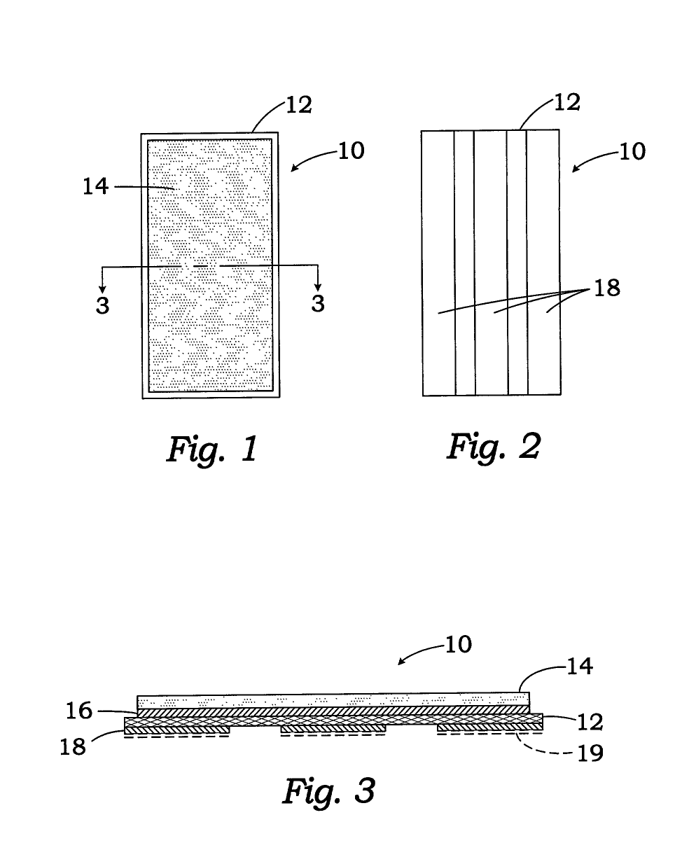

Turning more particularly to the drawings, FIGS. 1-3 illustrate snow melt paper 10 comprising a substrate 12 and a chemical de-icing composition 14 secured to substrate 12 by adhesive layer 16. One or more adhesive or strips 18 may be attached to the back of substrate 12. If strips 18 are adhesive strips, an additional wax paper strip 19 may cover strips 18 until snow melt paper 10 is ready for use. It should be appreciated that FIGS. 1-3 are illustrative of snow melt paper 10 only and are not intended to represent actual dimensions or proportions.

In the preferred embodiment, substrate 12 is a strong paper such as is used for coarse sandpaper. However, other substrates may be used. A fibrous, water-resistant substrate 12 may be used to withstand heavy traffic without breaking down or tearing. A porous substrate may also be used to allow melting water to pass through snow melt paper 10 and not accumulate on the surface.

In the preferred embodiment, de-icing composition 14 may comprise a commercially available, granular chloride salt blend which may include sodium chloride, potassium chloride, magnesium chloride hexahydrate and calcium chloride, such as Ice Melt®, for example. Composition 14 may also include abrasive or anti-slip materials such as sand, cinders and gravel, for example. Additionally, inclusion of a moisture absorbent such as calcined diatomaceous earth aborsbents may be desirable to aid in the anti-slip properties of the composition 14. The potential for the composition mix is unlimited to tailor the product to the specific end use.

Strips 18 help keep snow melt paper 10 in place and from moving or slipping when walked or driven over. Strips 18 can be made of sand or other rough material adhered to the back of substrate 12 such as coarse sandpaper that helps grip an uneven or soft surface. Strips 18 can also be made up of a commercially available pressure sensitive, water-resistant adhesive to secure snow melt paper 10 in place.

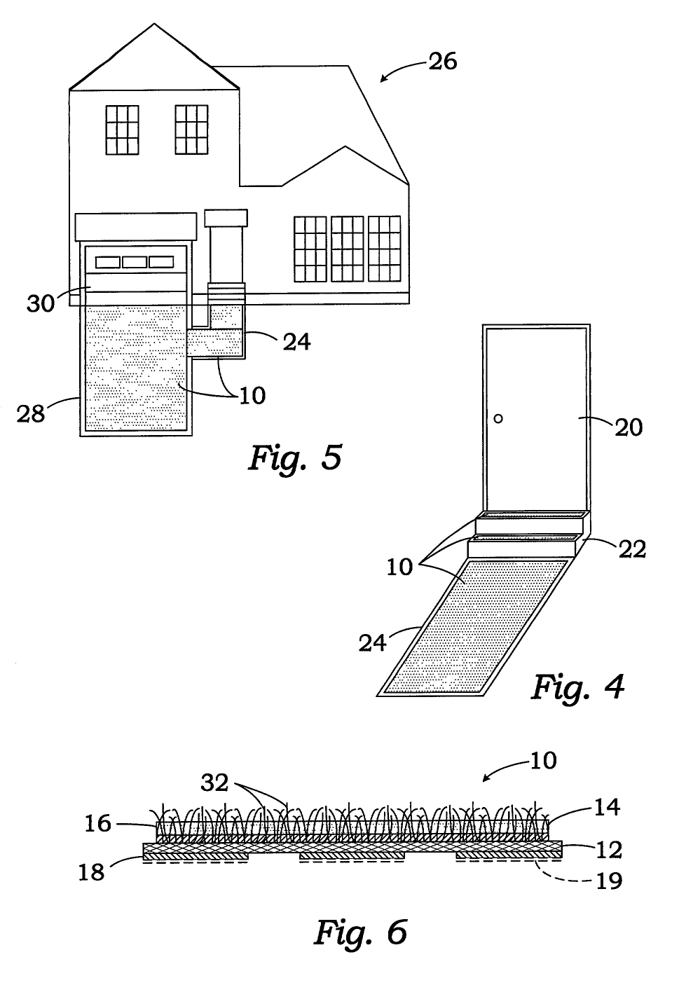

Referring to FIG. 4, snow melt paper 10 may be placed in front of a door 20 of a house 26 on steps 22 and along sidewalk 24. Snow melt paper 10 may be produced in pre-cut sheets sized to fit the common width of a step and in rolls the width of a sidewalk 24. Snow melt paper 10 may easily be trimmed to fit any surface.

Referring to FIG. 5, a large roll of snow melt paper 10 may be produced the width of a driveway 28 in front of garage door 30 for house 26, for example. Alternatively, narrower rolls of snow melt paper 10 may be laid in strips across or down driveway 28 to effectively cover the entire surface, or just the tire tracks.

Snow melt paper 10 may be installed or placed by simply removing the wax paper backing 19 from adhesive strip 18 and pressing the adhesive strips 18 of paper 10 firmly on the sidewalk or other surface. Depending on the amount of snow or ice accumulation, snow melt paper may remain in place for weeks or months eliminating the need to shovel the sidewalks or driveway, thus reducing the likelihood of injury from falls on a slick surface or over exertion from removing the snow. Additionally, the snow and ice is removed automatically, 24 hours a day eliminating repeated need to re-shovel the sidewalks and driveway. When the threat of snow or ice has passed, or the effectiveness of the snow melt paper 10 has diminished, the paper may be rolled up and thrown away.

Snow melt paper 10 may also be used in commercial applications such as on sidewalks in front of retail stores, shopping centers, restaurants, and schools. In these applications, substrate 12 may be a fibrous wear and water-resistant material such as canvas or tarp material. A heavier application of de-icing composition 14 may be used to compensate for the increased foot traffic. In this application, safe access to the business or school is ensured without the need to periodically remove additional accumulation of snow. Snow melt paper 10 may also be used on a flatbed truck or in the back of a pick up truck to eliminate the need to periodically remove the accumulated snow and ice.

In another embodiment (FIG. 6) substrate 12 may be a plastic turf-type doormat with de-icing composition 14 embedded below the plastic fibers 32 that extend above the surface. As shoes and boots are brushed over the mat to remove snow, the snow falls onto the de-icing composition 14 and melts preventing an accumulation of snow on the mat. The mat may include strips 18 on the back to prevent the mat from slipping on a porch, for example.

In addition to the advantages described above, snow melt paper 10 reduces environmental damage from de-icers and salts spread on the vegetation surrounding the treated surface. The de-icing composition 14 enters the environment only to the extent that it is dislodged from snow melt paper 10 or is dissolved in the melted water. Any remaining deicing composition 14 left after the threat of snow has passed and the snow melt paper 10 is no longer needed, is rolled or gathered along with substrate 12 and may be disposed of properly.

It is to be understood that while certain forms of this invention have been illustrated and described, it is not limited thereto, except insofar as such limitations are included in the following claims.

Having thus described the invention, what is claimed as new and desired to be secured by Letters Patent is as follows:

1. A sheet for inhibiting the accumulation of snow or ice comprising:
a substrate material having a top and bottom surface,
a de-icing composition secured to the top surface of said substrate material, and
an anti-slip material secured to the bottom surface of said substrate material, whereby melting snow or ice coming into contact with said de-icing composition.

2. The sheet as claimed in claim 1 wherein said substrate material is a paper.

3. The sheet as claimed in claim 1 wherein said substrate material is woven.

4. The sheet as claimed in claim 1 wherein said substrate material is plastic.

5. The sheet as claimed in claim 1 wherein said de-icing composition comprises a chloride salt selected from the group consisting of calcium chloride, sodium chloride, potassium chloride, magnesium chloride hexahydrate, and mixtures thereof.

6. The sheet as claimed in claim 1 wherein said de-icing composition further comprises an abrasive material.

7. The sheet as claimed in claim 1 wherein said de-icing composition further comprises a moisture absorbent.

8. The sheet as claimed in claim 1 wherein said anti-slip material is repositionable adhesive.

9. The sheet as claimed in claim 1 wherein said anti-slip material is an abrasive material.

10. The sheet as claimed in claim 1 wherein said substrate is perforated.

11. A mat for inhibiting the accumulation of snow or ice comprising:
a substrate material having a top and bottom surface and a fibrous material extending out of said top surface,
a de-icing composition secured to said top surface of said substrate material, and
an anti-slip material secured to said bottom surface of said substrate material, whereby melting snow or ice coming into contact with said de-icing composition.

12. The mat as claimed in claim 11 wherein said substrate material is plastic or rubber.

13. The mat as claimed in claim 11 wherein said substrate material is paper.

14. The mat as claimed in claim 11 wherein said substrate material is woven.

15. The mat as claimed in claim 11 wherein said de-icing composition comprises a chloride salt selected from the group consisting of calcium chloride, sodium chloride, potassium chloride, magnesium chloride hexahydrate, and mixtures thereof.

16. The mat as claimed in claim 11 wherein said de-icing composition further comprises a moisture absorbent.

17. The mat as claimed in claim 11 wherein said anti-slip material is repositionable adhesive.

18. The mat as claimed in claim 11 wherein said anti-slip material is abrasive.

19. The mat as claimed in claim 11 wherein said substrate material is perforated.
